(19) United States
(12) Patent Application Publication
(10) Pub. No.: US 2003/0187371 A1
(43) Pub. Date: Oct. 2, 2003

(54) Systems and methods for enhanced focused ultrasound ablation using microbubbles

(75) Inventors: Kobi Vortman, Haifa (IL); Shuki Vitek, Haifa (IL); Kullervo Hynynen, Medfield, MA (US)

Correspondence Address: BINGHAM, MCCUTCHEN LLP, THREE EMBARCADERO, SUITE 1800, SAN FRANCISCO, CA, 94111-4067, US

(73) Assignees: Insightec-TxSonics Ltd., Tirat Carmel (IL); The Brigham and Women's Hospital, Inc., Boston, MA

(21) Appl. No.: 10/112,252

(22) Filed: Mar. 27, 2002

(51) Int. Cl. A61H 1/00

(52) U.S. Cl. 601/3

(57) ABSTRACT

A system for performing a therapeutic procedure using focused ultrasound includes a piezoelectric transducer, drive circuitry coupled to the transducer for providing drive signals to the transducer, and a controller coupled to the drive circuitry for alternating an intensity of the drive signals between a plurality of intensities. Acoustic energy above a threshold intensity is transmitted by the transducer towards a target region to generate microbubbles in tissue within the target region. The intensity of the acoustic energy is reduced to discontinue generating microbubbles and heat the tissue, e.g., to necrose the tissue, without collapsing the generated microbubbles, the microbubbles enhancing the ability of the tissue in the target region to absorb the acoustic energy.

### FIELD OF THE INVENTION

The present invention relates generally to systems and methods for performing therapeutic procedures using focused ultrasound, and more particularly to systems and methods for enhanced tissue coagulation by generating microbubbles in a target tissue region.

### BACKGROUND

High intensity focused acoustic waves, such as ultrasonic waves (acoustic waves with a frequency greater than about 20 kilohertz), may be used therapeutically to treat internal tissue regions within a patient. For example, ultrasonic waves may be used to induce coagulation and/or necrosis in a target tissue region. In ultrasonic tissue coagulation, the ultrasonic waves are absorbed by tissue to generate heat in the tissue. The absorbed energy heats the tissue cells in the target region to temperatures that exceed protein denaturation thresholds, usually above 60° C., resulting in coagulation and/or necrosis.

During a focused ultrasound procedure, small gas bubbles, or “microbubbles,” may be generated in the liquid contained in the tissue when the ultrasonic waves are transmitted therethrough. Microbubbles may be formed due to tissue heating, the stress resulting from negative pressure produced by the propagating ultrasonic wave, and/or when the liquid ruptures and is filled with gas/vapor. Generally, steps are taken to avoid creating microbubbles in the tissue, because once created, they may collapse due to the applied stress from an acoustic field. This mechanism, called “cavitation,” may cause extensive tissue damage and may be difficult to control. U.S. Pat. No. 6,309,355 discloses using cavitation induced by an ultrasound beam to create a surgical lesion.

Accordingly, systems and methods for treating a tissue region using ultrasound energy would be useful.

### SUMMARY OF THE INVENTION

The present invention is directed to systems and methods for performing a therapeutic procedure using acoustic energy, and more particularly, to systems and methods for enhanced tissue coagulation by generating microbubbles in a target tissue region.

In accordance with one aspect of the present invention, a system is provided that includes a piezoelectric transducer, drive circuitry, and a controller. The drive circuitry is coupled to the transducer to provide drive signals to the transducer, causing the transducer to transmit acoustic energy, e.g., towards a focal zone within a tissue structure. The controller is coupled to the drive circuitry, and is configured for sequentially changing the amplitudes of the drive signals from an intensity sufficient to generate microbubbles in tissue within the focal zone to a reduced intensity sufficient to heat the tissue within the focal zone without causing collapse or cavitation of the generated microbubbles, e.g., until tissue coagulation and/or necrosis occurs. Since microbubbles may dissipate from the tissue within the focal zone after time has passed, the controller may periodically repeat the process by increasing the amplitudes of the drive signals to generate additional microbubbles and then reducing the intensity to heat the tissue without causing collapse of the microbubbles.

In accordance with another aspect of the present invention, a method is provided for treating a patient using focused ultrasound. Acoustic energy is directed at tissue at an intensity sufficient to generate microbubbles within a focal zone within the tissue. Acoustic energy at a lesser intensity is then directed at the focal zone to heat and/or necrose the tissue within the focal zone. The intensity of this second transmission is lower than the intensity needed to generate or cause collapse of the microbubbles. In order to maintain a population of microbubbles within the focal zone to enhance necrosis of the tissue during the sonication, the steps of directing acoustic energy above and below the threshold level may be alternately repeated one or more times during a single sonication.

Other objects and features of the present invention will become apparent from consideration of the following description, taken in conjunction with the accompanying drawings.

### BRIEF DESCRIPTION OF THE DRAWINGS

Preferred embodiments of the present invention are illustrated by way of example, and not by way of limitation, in the figures of the accompanying drawings, in which like reference numerals refer to like components, and in which:

FIG. 1A is a diagram of an ultrasound transducer focusing ultrasonic energy at a target tissue region within a patient;

FIG. 1B is a cross-sectional detail of the ultrasonic transducer and target tissue region of FIG. 1A with microbubbles generated in a focal zone of the transducer; and

FIG. 2 is a flowchart of a method for treating tissue using microbubbles to enhance heating, in accordance with the present invention.

### DETAILED DESCRIPTION OF THE PREFERRED EMBODIMENTS

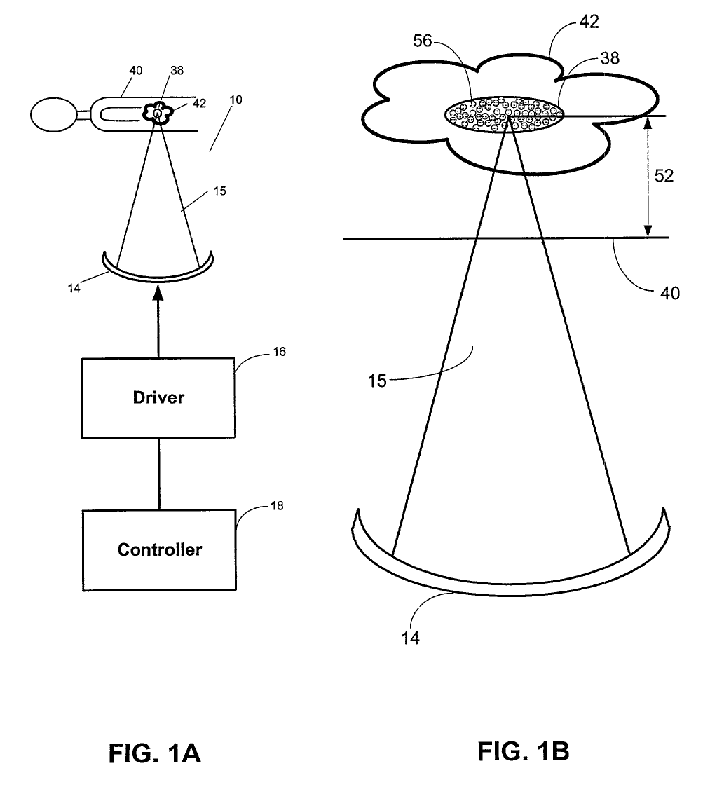

Turning to the drawings, FIGS. 1A and 1B show an exemplary embodiment of a focused ultrasound system 10 that includes an ultrasound transducer 14, drive circuitry 16 coupled to the transducer 14, and a controller 18 coupled to the drive circuitry 16. The transducer 14 may direct acoustic energy represented by beam 15 towards a target 42, typically a tumor or other tissue region, within a patient 40, as explained further below.

The transducer 14 may include a single piezoelectric transducer element, or may include multiple piezoelectric elements (not shown) together providing a transducer array. In one embodiment, the transducer 14 may have a concave or bowl shape, such as a “spherical cap” shape, i.e., having a substantially constant radius of curvature such that the transducer 14 has an inside surface defining a portion of a sphere. Alternatively, the transducer 14 may have a substantially flat configuration (not shown), and/or may include an outer perimeter that is generally, but not necessarily, circular. The transducer 14 may be divided into any desired number of elements (not shown). In one embodiment, the transducer 14 may have an outer diameter of between about eight and sixteen centimeters (8-16 cm), a radius of curvature between about eight and twenty centimeters (8-20 cm), and may include between ten and forty (10-40) rings and between four and sixteen (4-16) sectors.

In alternative embodiments, the transducer 14 may include one or more transducer elements having a variety of geometric shapes, such as hexagons, triangles, squares, and the like, and may be disposed about a central axis, preferably but not necessarily, in a substantially uniform or symmetrical configuration. The configuration of the transducer 14, however, is not important to the present invention, and any of a variety of ultrasound transducers may be used, such as flat circular arrays, linear arrays, and the like. Additional information on the construction of transducers appropriate for use with the present invention may be found, for example, in co-pending application Ser. No. 09/884,206, filed Jun. 9, 2001. The disclosure of this application and any references cited therein are expressly incorporated herein by reference.

The transducer 14 may be mounted within a casing or chamber (not shown) filled with degassed water or similar acoustically transmitting fluid. The chamber may be located within a table (not shown) upon which a patient 40 may be disposed, or within a fluid-filled bag mounted on a movable arm that may be placed against a patient's body (not shown). The contact surface of the chamber, e.g., the top of the table, generally includes a flexible membrane (not shown) that is substantially transparent to ultrasound, such as mylar, polyvinyl chloride (PVC), or other suitable plastic material. A fluid-filled bag (not shown) may be provided on the membrane that may conform easily to the contours of the patient 40 disposed on the table, thereby acoustically coupling the patient 40 to the transducer 14 within the chamber. In addition or alternatively, acoustic gel, water, or other fluid may be provided between the patient 40 and the membrane to facilitate further acoustic coupling between the transducer 14 and the patient 40.

A positioning system (not shown) may be connected to the transducer 14 for mechanically moving the transducer 14 in one or more directions, and preferably in any of three orthogonal directions. Alternatively, a focal distance (a distance from the transducer 14 to a focal zone 38 of the acoustic energy emitted by the transducer 14) may be adjusted electronically, mechanically, or using a combination of mechanical and electronic positioning, as is known in the art.

In addition, the system 10 may include an imaging device (not shown) for monitoring use of the system before or while treating a patient. For example, the system 10 may be used in conjunction with a magnetic resonance imaging (MRI) device, such as that disclosed in U.S. Pat. Nos. 5,247,935, 5,291,890, 5,368,031, 5,368,032, 5,443,068 issued to Cline et al., and U.S. Pat. Nos. 5,307,812, 5,323,779, 5,327,884 issued to Hardy et al., the disclosures of which are expressly incorporated herein by reference.

With particular reference to FIG. 1A, the transducer 14 is coupled to the driver 16 and/or the controller 18 for generating and/or controlling the acoustic energy emitted by the transducer 14. The driver 16 generates one or more electronic drive signals, which, in turn, are controlled by controller 18. The transducer 14 converts the electronic drive signals into acoustic energy represented by energy beam 15. The vibrational energy propagated by the transducer 14 is transmitted through the target medium within the chamber, such as degassed water.

The controller 18 and/or driver 16 may be separate or integral components of the transducer 14. It will be appreciated by one skilled in the art that the operations performed by the controller 18 and/or driver 16 may be performed by one or more controllers, processors, and/or other electronic components, including software or hardware components. Thus, the controller 18 and/or the driver 16 may be provided as parts of the transducer 14, and/or as a separate subsystem. The terms controller and control circuitry may be used herein interchangeably, and the terms driver and drive circuitry may be used herein interchangeably.

The driver 16 may generate drive signals in the ultrasound frequency spectrum that may be as low as twenty kilohertz (20 KHz), and that typically range from 0.5 to 10 MHz. Preferably, the driver 16 provides electrical drive signals to the transducer 14 at radio frequencies (RF), for example, between about 0.5-10 MHz, and more preferably between about 0.5 and 3.0 MHz. When electrical drive signals are provided to the transducer 14, the transducer 14 emits acoustic energy 15 from its inside surface, as is well known to those skilled in the art.

The controller 18 may control a phase component of the drive signals to respective elements of the transducer 14, e.g., to control a shape of a focal zone 38 generated by the transducer 14 and/or to move the focal zone 38 to a desired location. For example, the controller 18 may control the phase shift of the drive signals based upon a radial position of respective transducer elements of the transducer 14, e.g., to adjust a focal distance of the focal zone (i.e., the distance from the face of the transducer 14 to the center of the focal zone 38). In addition or alternatively, the controller 18 may control the positioning system to move the transducer 14, and consequently the location of the focal zone 38 of the transducer to a desired location, i.e., within the target tissue region 42.

The controller 18 may also control amplitude (and/or other aspects) of the drive signals, and therefore, the intensity or power level of the acoustic waves transmitted by the transducer 14. For example, the controller 18 may cause the drive circuitry 16 to provide drive signals to the transducer 14 above a threshold such that the acoustic energy emitted by the transducer 14 may generate microbubbles in fluid within tissue in the focal zone. Subsequently, the controller 18 may lower the intensity below the threshold to a level at which no microbubbles are formed in the tissue within the focal zone, yet may still necrose, coagulate, or otherwise heat tissue, as explained below.

During use, a patient 40 may be disposed on the table with water, acoustically conductive gel, and the like applied between the patient 40 and the bag or membrane, thereby acoustically coupling the patient 40 to the transducer 14. The transducer 14 may be focused towards a target tissue region within a tissue structure 42, which may, for example, be a cancerous or benign tumor. The transducer 14 may be activated by supplying a set of drive signals at one or more frequencies to the transducer 14 to focus acoustic energy at the target tissue region 42, represented by energy beam 15. As the acoustic energy 15 passes through the patient's body, the acoustic energy 15 is converted to heat, which may raise the temperature of the target mass 42. The acoustic energy 15 may be focused on the target mass 42 to raise the temperature of the target mass tissue 42 sufficiently to coagulate and/or necrose the tissue 42, while minimizing damage to surrounding healthy tissue.

In order to optimize a therapeutic procedure, the system 10 should be operated to achieve a maximal coagulation rate (coagulated tissue volume/time) in the target tissue region, while minimizing heating in the surrounding tissue, particularly within the near field region (the region between the transducer 14 and the focal zone 38). The coagulation rate may be optimized by achieving preferential absorption of the ultrasonic waves, where the absorption by the tissue within the focal zone 38 is higher than the tissue outside the focal zone 38. The presence of microbubbles 56 in tissue within the focal zone 38 (shown in FIG. 1B) may achieve this goal, because tissue including microbubbles 56 therein may have a higher energy absorption coefficient than the surrounding tissue without microbubbles.

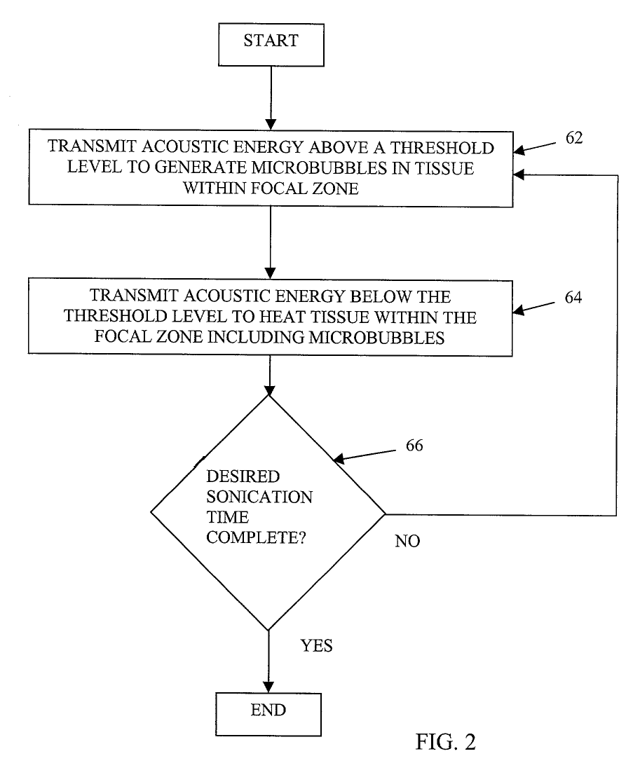

FIG. 2 illustrates an overview of a method for heating tissue within a target region, e.g., to induce tissue coagulation and/or necrosis during a sonication that includes a series of acoustic energy transmissions at different intensities. Initially, a target tissue structure 42 (not shown, see FIG. 1B) may be selected for treatment, e.g., a benign or malignant tumor within an organ, such as a liver, kidney, uterus, breast, brain, and the like. At step 62, ultrasonic waves above a certain threshold intensity may be directed towards the target tissue structure 42 to generate microbubbles 56 within focal zone 38. Although this threshold intensity may differ with each patient and/or tissue structure, appropriate threshold intensities may be readily determined by those skilled in the art.

Transmission of acoustic energy at the intensity above the threshold level may be relatively brief, e.g., having a duration of about three seconds or less, and preferably having a duration of not more than about 0.1-0.5 second, yet sufficiently long to generate microbubbles within the focal zone 38 without substantially generating microbubbles in tissue outside the focal zone 38, e.g., in near field 52 (not shown, see FIG. 1B).

At step 64, the intensity may be lowered below the threshold level and, maintained at a lower intensity while remaining focused substantially at the focal zone 38 so as to heat the tissue within the focal zone 38 without collapsing the microbubbles 56 within the focal zone 38. For example, this lower intensity level may be reduced below the intensity used to generate the microbubbles 56 by a factor of about two or three. The transmission at this lower intensity may have a substantially longer duration as compared to the transmission at the higher intensity used to generate the microbubbles 56. For example, the acoustic energy may be transmitted for at least about two or three seconds (2-3 s.), and preferably about eight to ten seconds (8-10 s.). For example, microbubbles 56 generated within tissue may be present for as little as eight to ten seconds (8-10 s.), e.g., due to natural perfusion of the tissue. Thus, the acoustic energy may be maintained for only as long as sufficient supply of microbubbles are present. Because of the microbubbles 56, acoustic energy absorption by the tissue within the focal zone 38 may be substantially enhanced, as explained above.

At step 66, the controller 18 (not shown, see FIG. 1A) may determine whether the sonication has been sufficiently long to heat the tissue within the focal zone 38 to a desired level, e.g., to coagulate or otherwise necrose the tissue within the focal zone 38. If not, additional microbubbles may be generated in the target tissue region, e.g., by repeating step 62, and then the intensity may be reduced to heat the tissue while avoiding causing collapse of the microbubbles, e.g., by repeating step 64. Steps 62 and 64 may be repeated periodically, e.g., one or more times, during the sonication until sufficient time has passed to substantially ablate or otherwise treat the tissue within the focal zone 38.

Thus, a single sonication, which may last between five and twenty (5-20) seconds, and preferably, about ten (10) seconds or more, may include multiple transmissions above and below the threshold necessary to generate microbubbles. For example, after perfusion has at least partially dispersed the microbubbles from the tissue within the focal zone, transmission at an intensity above the threshold level may be repeated in order to maintain a level of microbubble density sufficient to create preferential absorption of the tissue within the focal zone. Transmission of acoustic energy at an intensity below the threshold level may then be repeated to cause heating of the tissue within the focal zone without causing bubble collapse. The intensity levels of the acoustic energy may be set to switch between a single level above and a single level below the threshold intensity. Alternatively, the intensities may be varied during the course of the sonication. This alternating sequence of acoustic transmissions may be localized and timed in such a way as to create and maintain a microbubble “cloud” in the target tissue region to optimize the coagulation process.

Upon completing the sonication, the transducer 14 may be deactivated, e.g., for sufficient time to allow heat absorbed by the patient's tissue to dissipate. The transducer 14 may then be focused on another portion of the target tissue region 42, e.g., adjacent the previously treated tissue, and the process repeated, as shown in FIG. 2. Alternatively, the acoustic beam may be steered continuously or discretely without any cooling time, e.g., using a mechanical positioner or electronic steering.

This alternating sequence during a single sonication may provide several advantages as compared to conventional focused ultrasound (“FUS”) ablation without microbubbles. For example, if an intensity level is utilized in the heating without bubble collapse step (step 64) that is comparable to conventional FUS ablation, a substantially larger focal zone 38 may created. For example, due to the enhanced energy absorption, the resulting focal zone 38 may be about two to three times larger than conventional FUS ablation, thereby necrosing or otherwise heating a larger volume of tissue within the target tissue structure 42. This increased ablation volume may require fewer sonications to a ablate an entire target tissue structure.

Alternatively, a lower intensity level may be used as compared to conventional FUS, thereby generating a comparably sized focal zone while using substantially less energy. This may reduce energy consumption by the system 10 and/or may result in substantially less energy being absorbed by surrounding tissue, particularly in the near field. With less energy absorbed, cooling times between sonications may be substantially reduced. For example, where conventional FUS may require ninety seconds or more of cooling time between sonications, systems and methods in accordance with the present invention may allow cooling times of about forty seconds or less.

Thus, in either case, an overall treatment time to ablate or otherwise treat a target tissue structure may be substantially reduced as compared to conventional FUS without microbubbles.

While the invention is susceptible to various modifications and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

What is claimed is:

1. A system for performing a therapeutic procedure in a target tissue region of a patient, comprising:
a transducer;
drive circuitry coupled to the transducer for providing drive signals to the transducer such that the transducer transmits acoustic energy towards a focal zone; and
a controller coupled to the drive circuitry, the controller configured for sequentially changing intensities of the drive signals provided by the drive circuitry from an intensity sufficient to generate microbubbles in tissue within the focal zone, to an intensity sufficient to heat the tissue within the focal zone without causing collapse of the generated microbubbles.

2. The system of claim 1, wherein the controller is configured for increasing the intensity of the drive signals after sufficient time for the microbubbles to at least partially dissipate in order to generate additional microbubbles.

3. The system of claim 1, wherein the controller is configured for controlling the drive circuitry such that a duration of the drive signals at the intensity sufficient to generate microbubbles is substantially shorter than a duration of the drive signals at the intensity sufficient to heat tissue without causing collapse of the microbubbles.

4. The system of claim 3, wherein the duration of the drive signals at the intensity sufficient to generate microbubbles is not more than about three seconds.

5. The system of claim 3, wherein the duration of the drive signals at the intensity sufficient to heat tissue is greater than not less than about two seconds.

6. The system of claim 1, wherein the transducer comprises a multiple element transducer array, and wherein the controller is further configured for controlling a phase component of the drive signals to each element in the transducer array to at last partially focus the acoustic energy transmitted by the transducer at the focal zone.

7. The system of claim 1, wherein the controller is configured for controlling the drive circuitry such that the intensity of the drive signals sufficient to heat tissue without causing collapse of the microbubbles is at most half the intensity sufficient to generate microbubbles.

8. The system of claim 1, wherein the controller is configured for controlling the drive circuitry such that the intensity of the drive signals sufficient to heat tissue without causing collapse of the microbubbles is at most one third the intensity sufficient to generate microbubbles.

9. A method for performing a therapeutic procedure in a target tissue region of a patient using focused ultrasound, the method comprising:
directing acoustic energy of a first intensity at a focal zone to generate microbubbles in tissue within the focal zone; and
directing acoustic energy of a second intensity at the focal zone to heat tissue within the focal zone, the second intensity being less than the first intensity and less than a threshold intensity necessary to cause collapse of the microbubbles generated in the tissue.

10. The method of claim 9, wherein directing acoustic energy of a first intensity at the focal zone generates microbubbles in tissue in the focal zone without generating substantial microbubbles in tissue outside the focal zone.

11. The method of claim 9, wherein acoustic energy of a third intensity is directed at the focal zone after the microbubbles have at least partially dispersed from the focal zone to generate additional microbubbles.

12. The method of claim 10, wherein acoustic energy of the third intensity is substantially equal to acoustic energy of the first intensity.

13. The method of claim 10, wherein acoustic energy of a fourth intensity is directed at the focal zone after the additional microbubbles are generated in the tissue, the fourth intensity being less than the third intensity and less than the threshold necessary to cause collapse of the additional microbubbles generated in the tissue.

14. The method of claim 13, wherein acoustic energy of the fourth intensity is substantially equal to acoustic energy of the second intensity.

15. The method of claim 9, wherein a duration of directing acoustic energy of the second intensity is greater than a duration of directing acoustic energy of the first intensity at the tissue within the focal zone.

16. The method of claim 9, further comprising sequentially repeating the steps of directing acoustic energy at the first and second intensities while maintaining the focal zone within the target tissue region, thereby substantially maintaining microbubbles within the focal zone during a single, substantially continuous sonication.

17. The method of claim 9, further comprising sequentially repeating the steps of directing acoustic energy at the first and second intensities after the microbubbles have at least partially dissipated from tissue within the focal zone.

18. The method of claim 9, wherein directing acoustic energy of a second intensity at the focal zone to heat tissue within the focal zone results in at least one of coagulation and necrosis of the tissue within the focal zone.

19. The method of claim 9, wherein the second intensity is not more than half of the first intensity.

20. The method of claim 9, wherein a duration of directing acoustic energy of the first intensity is not more than about three seconds.

21. The method of claim 9, wherein a duration of directing acoustic energy of the second intensity is at least about two seconds.

22. A method for performing a therapeutic procedure in a target tissue region of a patient using focused ultrasound, the method comprising:
(a) directing acoustic energy at a tissue region of sufficient intensity to generate microbubbles within the target tissue region;
(b) reducing the intensity to heat tissue within the target tissue region while avoiding collapsing the microbubbles until the microbubbles have at least partially dissipated; and
(c) sequentially repeating steps (a) and (b) for a sufficient amount of time to necrose tissue within the target tissue region.

23. The method of claim 22, wherein a duration of step (a) is substantially less than a duration of step (b).

24. The method of claim 22, wherein the intensity to heat tissue within the tissue region is not more than about half of the intensity sufficient to generate microbubbles.

25. The method of claim 22, wherein a duration of directing acoustic energy of the intensity sufficient to generate microbubbles is not more than about three seconds.

26. The method of claim 22, wherein a duration of directing acoustic energy of the intensity to heat tissue within the tissue region until the microbubbles have substantially dissipated is at least about two seconds.
